(19) United States
(12) Patent Application Publication
(10) Pub. No.: US 2018/0022257 A1
(43) Pub. Date: Jan. 25, 2018

(54) METHOD FOR CONNECTING COMPONENTS OF A VEHICLE SEAT AND VEHICLE SEAT

(71) Applicant: Adient Luxembourg Holding S.à.r.l., Luxembourg (LU)

(72) Inventors: Andreas DANNHEISIG, Sassenberg (DE); Maximilian PLATVOET, Remscheid (DE); Volker SCHMIDT, Wetter (DE)

(21) Appl. No.: 15/548,996

(22) PCT Filed: Feb. 3, 2016
(86) PCT No.: PCT/EP2016/052266

§ 371 Date: Aug. 4, 2017

(30) Foreign Application Priority Data
Feb. 6, 2015 (DE) 10 2015 202 154.8

(51) Int. Cl. B60N 2/68; C09J 5/06

(52) U.S. Cl. CPC B60N 2/682; C09J 5/06; C09J 2201/128; C09J 2203/30

(57) ABSTRACT

A method for connecting a first component (1) of a vehicle seat to a second component (2) of the vehicle seat includes applying a first glue (3) to the first component (1). The first component (1) is at least temporarily fastened to the second component (2) by a fastener. The first glue (3) is cured by supplying heat, such that the first component (1) is permanently connected to the second component (2). The fastener is a second glue (4). A vehicle seat is also provided including a first component (1) and a second component (2). The first component (1) is connected to the second component (2) in a main connection region (5) by a first glue (3). The first component (1) is connected to the second component (2) in an auxiliary connection region (6) by a fastener comprising a second glue (4).

### CROSS REFERENCE TO RELATED APPLICATIONS

This application is a U.S. National Phase Application of International Application PCT/EP2016/052266, filed Feb. 3, 2016, and claims the benefit of priority under 35 U.S.C. §119 of German Application 10 2015 202 154.8, filed Feb. 6, 2015, the entire contents of which are incorporated herein by reference.

### FIELD OF THE INVENTION

The invention relates to a method for connecting a first component of a vehicle seat to a second component of the vehicle seat, —wherein, in a first method step, a first adhesive means (a first adhesive) is applied to the first component, —wherein, in a second method step, the first component is fixed at least temporarily to the second component by way of a fixing means, and—wherein, in a third method step, the first adhesive means is cured by supplying heat, such that the first component is connected permanently to the second component.

The invention further relates to a vehicle seat comprising a first component and comprising a second component, wherein the first component is connected to the second component by way of a first adhesive means (a first adhesive) in a main connecting region, and wherein the first component is connected to the second component by way of a fixing means (fastener means or fastener) in an auxiliary connecting region.

### BACKGROUND OF THE INVENTION

Vehicle seats generally have a multiplicity of interconnected components, such as for example components of the backrest or of the seat surface. The individual connections between the components have to satisfy high demands. By way of example, it is necessary that, in the case of an accident, the components of the vehicle seat do not detach from one another as a result of the considerable forces acting on the vehicle seat.

To connect the components of vehicle seats, use is generally made of adhesive means in the form of crash-resistant 1-component adhesives, which are cured by supplying heat. During the production of such vehicle seats, the adhesive means is usually applied firstly to a first component. In a further step, a second component, which is to be connected to the first component by way of the adhesive means, is then fixed to the first component. The fixing makes it possible to handle and/or to transport the two components together before the curing. For fixing the components, use is usually made of mechanical fixing means, such as for example rivets.

In practice, the known method has proved to be entirely suitable. However, it has been found to be disadvantageous that increased production costs arise as a result of the mechanical fixing means used for fixing the components and the systems required for introducing these fixing means.

### SUMMARY OF THE INVENTION

Against this background, it is an object of the present invention to reduce the costs for producing a vehicle seat.

The object is achieved by a method for connecting a first component of a vehicle seat to a second component of the vehicle seat, —wherein, in a first method step, a first adhesive means (a first adhesive) is applied to the first component, —wherein, in a second method step, the first component is fixed at least temporarily to the second component by way of a fixing means (fastener means or fastener), and—wherein, in a third method step, the first adhesive means is cured by supplying heat, such that the first component is connected permanently to the second component, wherein the fixing means is a second adhesive means (a second adhesive).

According to the invention, the fixing means used for temporarily fixing the two components is configured as an adhesive means. It is therefore not necessary to provide mechanical fixing means on the first component and/or on the second component in order to temporarily fix the components between the application of the first adhesive means and the curing of the first adhesive means. By dispensing with mechanical fixing means, it is possible to reduce the costs for producing the vehicle seat.

The method according to the invention is preferably used for those components of a vehicle seat which are configured as components of a backrest or as components of a seat surface.

The second adhesive means is preferably different to the first adhesive means. The choice of different adhesive means for briefly fixing the components to one another during the production of the vehicle seat and for the ultimate crash-resistant connection of the two components makes it possible to choose adhesive means which are respectively suitable for these different tasks.

In order to make it possible to achieve a crash-resistant connection of the two components of the vehicle seat, the first adhesive means is preferably configured as an in particular crash-resistant 1-component adhesive. The first adhesive means can preferablybe cured by supplying heat.

The second adhesive means is preferably a fast-curing adhesive, such that the two components can be fixed to one another without it being necessary to cure the second adhesive means over a longer period of time. It is particularly preferable for the second adhesive means to be a fast-curing 2-component adhesive, as a result of which the curing of the second adhesive means can be accelerated. Alternatively, the second adhesive means can be configured as a double-sided adhesive tape, such that fast fixing of the components can be achieved. It is advantageous if the double-sided adhesive tape has a high tack.

A refinement in which the second adhesive means is cured by supplying heat has proved to be advantageous. The second adhesive means is preferably selectively cured, which means that, during the curing of the second adhesive means, the first adhesive means is not cured or is cured only slightly.

In this context, it is preferred if the heat for curing the second adhesive means is supplied by a heating element, in particular by a fast-acting heating element. It is particularly preferable for a plurality of heating elements to be provided, with one heating element being assigned to each fixing point which connects the first component and the second component.

It is advantageous if the heating element is arranged in a clamping apparatus, by way of which the first component and the second component can be braced against one another.

For curing the first adhesive means, the two components fixed to one another are preferably introduced into a furnace. By way of example, the furnace can be configured as a furnace of an electrophoretic deposition apparatus, in particular of a cathodic dip coating (CDC) apparatus. This entails the advantage that the first adhesive means can be cured together with a coating applied to the components in a common step. In this respect, the sequence of the production method can be accelerated.

According to an advantageous refinement, the first adhesive means is arranged in a main connecting region of the first component and the second adhesive means is arranged in an auxiliary connecting region of the first component, wherein the main connecting region has a greater area than the auxiliary connecting region. It is preferable that the auxiliary connecting region is arranged in the marginal region of the first component, in particular directly at an edge and/or corner of the first component. The auxiliary connecting region can be arranged at the margin of the main connecting region. Alternatively, the auxiliary connecting region can be arranged in a neutral fiber of the first component.

In the case of a vehicle seat comprising a first component and comprising a second component, wherein the first component is connected to the second component by way of a first adhesive means in a main connecting region, and wherein the first component is connected to the second component by way of a fixing means in an auxiliary connecting region, the object mentioned in the introduction is achieved in that the fixing means is a second adhesive means.

The same advantages as those which have already been described in conjunction with the method according to the invention arise in the case of the vehicle seat according to the invention.

A preferred refinement provides that the second adhesive means is a fast-curing adhesive. It is particularly preferable for the second adhesive means to be a fast-curing 2-component adhesive. Alternatively, the second adhesive means can be configured as a double-sided adhesive tape, such that fast fixing of the components can be achieved. It is advantageous if the double-sided adhesive tape has a high tack.

The advantageous features described in conjunction with the method can also be employed alternatively or additionally in the case of the vehicle seat.

Further details and advantages of the invention will be explained hereinbelow on the basis of an exemplary embodiment shown in the drawings

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of a plurality of components of a backrest of a vehicle seat; and

FIG. 2 is a sectional illustration through a backrest held in a clamping apparatus as shown in FIG. 1.

### DESCRIPTION OF THE PREFERRED EMBODIMENTS

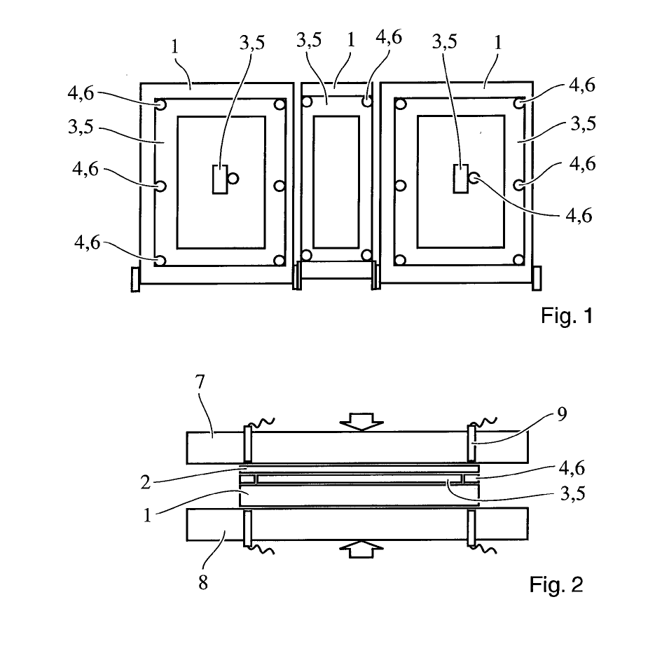

Referring to the drawings, FIG. 1 shows a plurality of components 1 of a separable backrest of a vehicle seat, configured as a back seat, in a schematic sectional illustration. The first components 1 of the backrest, which are shown, are connected to second components (not shown in FIG. 1) by way of an adhesive connection. The adhesive connection is made by way of one or more main connecting regions 5 of the first component 1, in which a first adhesive means 3 is arranged. The first adhesive means is configured as a crash-resistant 1-component adhesive which can be cured in a furnace. For the curing, the components 1, 2 to be connected are preferably introduced into a furnace of a cathodic dip coating system.

In order to prevent the components 1, 2 to be connected from moving with respect to one another upon transportation into the furnace, the components 1, 2 are fixed to one another by way of a fixing means after the application of the first adhesive means 3. The fixing means is a second adhesive means 4, which is applied in an auxiliary connecting region 6 of the first component 1. It is therefore not necessary to provide mechanical fixing means on the first component 1 and/or on the second component 2 in order to temporarily fix the components 1, 2 between the application of the first adhesive means 3 and the curing of the first adhesive means 3. By dispensing with mechanical fixing means, it is possible to reduce the costs for producing the vehicle seat.

The second adhesive means 4 is not identical to the first adhesive means 3. According to the exemplary embodiment, the second adhesive means 4 is configured as a fast-curing 2-component adhesive. Alternatively, the second adhesive means 4 can be a double-sided adhesive tape with a high tack. As can be gathered from the illustration in FIG. 1, a plurality of auxiliary connecting regions 6 are provided in each case for the components 1. The auxiliary connecting regions 6 have a smaller overall area compared to the main connecting regions 5. The auxiliary connecting regions 6 are arranged at the margin and/or in the region of a corner of the main connecting regions 5. An identical second adhesive means 4 can be applied in each case in the auxiliary connecting regions 6, or different second adhesive means 4 can be used in the individual auxiliary connecting regions 6.

To produce a vehicle seat which has a backrest shown in FIG. 1, use is made of a method which will be described hereinbelow.

In a first method step, the first adhesive means 3 is applied to the first component 1. The first adhesive means 3 is preferably applied in a main connecting region 5 of the first component 1.

Thereafter, in a second method step, the first component 1 is at least temporarily fixed to the second component 2 by way of the fixing means configured as a second adhesive means 4. As can be gathered from the illustration in FIG. 2, the second adhesive means 4 is arranged between the first component 1 and the second component 2. The second adhesive means 4 is applied in an auxiliary connecting region 6 adjoining the main connecting region 5. Then, the first component 1 is braced to the second component 2 by way of a clamping apparatus 7, 8. To this end, the first component 1 and the second component 2 are introduced between an upper part 7 and a lower part 8 of the clamping apparatus. Those sides of the first component 1 and of the second component 2 which are remote from the main connecting region 5 bear respectively against the upper part 7 and the lower part 8 of the clamping apparatus. A plurality of heating elements 9 configured as fast-acting heating elements are arranged in the upper part 7 and/or the lower part 8 and are used to cure the second adhesive means 4 applied in the auxiliary connecting regions 6.

After the curing of the second adhesive means 4, the first component 1 and the second component 2, which is fixed to the first component 1, are together fed to a cathodic dip coating system. Under the supply of heat which is carried out during the cathodic dip coating, the first adhesive means 1 is cured, such that the first component 1 is connected permanently to the second component 2.

The above-described method and the vehicle seat entail the advantage that it is possible to dispense with mechanical fixing means for fixing the first component 1 to the second component 2. As a result, the costs for producing the vehicle seat can be reduced. In addition, impairments in terms of appearance of the vehicle seat resulting from the mechanical fixing means are avoided. Further advantages of the method lie in the fact that the influencing of the main connecting regions 5 by the auxiliary connecting regions 6 is reduced owing to the small size of the auxiliary connecting regions 6 and the positioning thereof outside the force flow. Furthermore, the weight of the vehicle seat is reduced owing to the omission of the mechanical fixing means.

While specific embodiments of the invention have been shown and described in detail to illustrate the application of the principles of the invention, it will be understood that the invention may be embodied otherwise without departing from such principles.

1. A method for connecting a first component of a vehicle seat to a second component of the vehicle seat, the method comprising the steps of:
applying a first adhesive to the first component;
fixing the first component at least temporarily to the second component by a fastener; and
curing the first adhesive by supplying heat, such that the first component is connected permanently to the second component, wherein the fastener is a second adhesive.

2. The method as claimed in claim 1, wherein the second adhesive is different from the first adhesive.

3. The method as claimed in claim 1, wherein the first adhesive is configured as a crash-resistant 1-component adhesive.

4. The method as claimed in claim 1, wherein the second adhesive is a fast-curing 2-component adhesive.

5. The method as claimed in claim 1, wherein the second adhesive is configured as a double-sided adhesive tape.

6. The method as claimed in claim 1, wherein the second adhesive is cured by supplying heat.

7. The method as claimed in claim 6, wherein the second adhesive is selectively cured in such a manner that, during the curing of the second adhesive, the first adhesive is not cured or is cured only slightly.

8. The method as claimed in claim 6, wherein heat for curing the second adhesive is supplied by a heating element.

9. The method as claimed in claim 8, wherein the heating element is arranged in a clamping apparatus, by way of which the first component and the second component are braced against one another.

10. The method as claimed in claim 1, wherein the two components fixed to one another are introduced into a furnace.

11. The method as claimed in claim 1, wherein the first adhesive is arranged in a main connecting region of the first component and the second adhesive is arranged in an auxiliary connecting region of the first component, wherein the main connecting region has a greater area than the auxiliary connecting region.

12. The method as claimed in claim 11, wherein the auxiliary connecting region is arranged in a marginal region of the first component, at an edge and/or corner of the first component.

13. A vehicle seat comprising:
a first component;
a second component;
a first adhesive; and
a second adhesive, wherein the first component is connected to the second component by way of the first adhesive in a main connecting region, and wherein the first component is connected to the second component by way of a fastener in an auxiliary connecting region, wherein the a fastener is the second adhesive.

14. The vehicle seat as claimed in claim 13, wherein the second adhesive is a fast-curing 2-component adhesive.

15. The vehicle seat as claimed in claim 13, wherein the first component and the second component are configured as components of a backrest.

16. The vehicle seat as claimed in claim 13, wherein the second adhesive is configured as a double-sided adhesive tape.

17. The vehicle seat as claimed in claim 13, wherein the first component and the second component are configured as components of a seat surface of the vehicle seat.
